(19) United States
(12) Patent Application Publication
(10) Pub. No.: US 2006/0240397 A1
(43) Pub. Date: Oct. 26, 2006

(54) Apparatus that helps facilitate clean hands and teeth

(76) Inventors: John Morris Lynn, Austin, TX (US); Kathryn A. Newth, Round Rock, TX (US)

Correspondence Address: John Lynn, 333 King Arthur Ct., Austin, TX, 78746, US

(21) Appl. No.: 11/111,297

(22) Filed: Apr. 21, 2005

(51) Int. Cl. G09B 25/00

(52) U.S. Cl. 434/365

(57) ABSTRACT

A method and apparatus are disclosed for helping facilitate the more effective washing of a person's hands and the brushing of a person's teeth. The apparatus is comprised of a means of sharing information on hand washing and a means of sharing information on tooth brushing. Preferably, the means of sharing this information, is a speaker means which is activated by either a hand washing activation means or a tooth brushing activation means.

### CROSS REFERENCE TO RELATED APPLICATIONS

This patent application is claiming priority under 35 USC 119(e) to provisional patent application entitled “Clean Hands and Clean Teeth Assured” having a provisional application Ser. No. 60/567,674 and filing date of May 3, 2004; and provisional patent application entitled “Apparatus that Helps Facilitate Clean Hands and Teeth” having a provisional application Ser. No. 60/569,679 and filing date of May 10, 2004.

### TECHNICAL FIELD OF THE INVENTION

The present invention relates in general to the field of personal hygiene and an apparatus to help assure clean teeth and clean hands.

### BACKGROUND OF THE INVENTION

There is a great desire that people (especially children) wash their hands more frequently and effectively and also brush their teeth more frequently and effectively. The US Center for Disease Control has stated that “The most important thing you can do to keep from getting sick is to wash your hands”. And yet, many people, through lack of knowledge, poor habits or simple negligence either do not wash their hands frequently enough or effectively enough. Likewise, it is well known that effective brushing of teeth (e.g. for some minimum period of time, normally said to be 2 minutes) is important to help prevent cavities and gum disease. Yet, a common complaint of parents is that their children do not brush their teeth for a sufficient period of time.

Currently some parents are trying to address hand washing and tooth brushing frequency and efficacy by vigilantly monitoring their children. In other words, actually watching them wash their hands and brush their teeth. Obviously, personal monitoring is not always possible and therefore this method is not always effective.

Presently there are both patented and un-patented systems intended to address the problem of insufficient hand washing. Prior art systems are typically very complex and, accordingly, prohibitively expensive. U.S. Pat. No. 5,670,945, for example, discloses a complex system that has a sanitizing basin with moisture proof switches inside the sanitizing basin and proximity detectors. A person must insert both hands simultaneously into the sanitizing basin in order to initiate the desired output signal. U.S. Pat. Nos. 6,426,701; 5,945,910; 5,812,059; 5,202,666; 4,896,144; 3,967,478; 5,610,589; 4,688,585 and 5,199,188 and US Patent Applications 20030030562; 20030197122; 20030019536; and 20040001009 all involve relatively complex systems containing such things as complex electronics, location sensors; pumps and so forth (often mixed together in complex attempts to require hand washing). In summary, the presently available systems are typically expensive, complex to install, difficult to maintain and it can be difficult to train users in their operation.

Likewise, there are technologies in the prior art which disclose methods and apparatuses to help improve the process of brushing of teeth. One of the main technologies in use, has been focused on assuring that teeth are brushed for some minimum amount of time. Examples include timers for tooth brushing as set forth in U.S. Pat. Nos. 6,345,015; 5,570,325; 5,561,884; 5,438,726; 5,189,959; 5,864,288; 4,991,755; 4,934,940; and 4,336,415.

There is no prior art which discloses a method or apparatus which both helps to facilitate hand washing and the brushing of teeth.

### SUMMARY OF THE INVENTION

There is a need for a simple, inexpensive method and apparatus to help assure that people (especially children) both wash their hands frequently and effectively and brush their teeth effectively and for a period of time sufficient to help assure that the teeth are clean. Especially desirable is a system that is simple and inexpensive enough to allow it to be put into almost any setting without costly retrofitting of bathrooms or hand washing areas.

In accordance with the present invention, a method and apparatus are disclosed for helping to assure the washing of hands and effective brushing of teeth that provide advantages over prior sanitization assurance schemes.

According to one aspect of the present invention, a method for helping to assure washing of hands and brushing of teeth preferably involves an apparatus with a speaker means (it may also be possible to have two separate speaker means). The speaker means is triggered by two separate activation means: (1) a hand washing activation means that is activated as a user washes their hands; and (2) a tooth brushing activation means that is activated as a user brushes their teeth. The speaker means has different outputs depending on which activation means is triggered (i.e. either information on hand washing or information on tooth brushing). (Note: it may be possible to use a single activation means, such as a single button, which has a switch that allows it to be set for either hand washing or tooth brushing. Depending on what the switch is set for, it gives a different input to the speaker means which then outputs the specific information desired on either hand washing or tooth brushing).

The hand washing activation means triggers the speaker means to give the user information that may be helpful in promoting better hand washing (e.g. how long a period of time they should wash their hands—normally a minimum of 15-20 seconds with soap and water—and/or other tips and instructions concerning hand washing). The tooth brushing activation means triggers the speaker to give information to the user which may be helpful in promoting better tooth brushing (e.g. how long a period of time they should brush their teeth-normally a minimum of 2 minutes-and/or other tips concerning tooth brushing methods).

In an exemplary embodiment of the present invention, the subject apparatus may be a standalone device which may be placed on the counter beside a home wash basin or mounted on a wall beside the wash basin or sink. Since the subject invention is typically implemented as a standalone device, it may be desirable to have a means of coercing persons to utilize the hand wash activation means and tooth brush activation means. This coercion may preferably be done by either (1) making the speaker means loud enough that parents outside of the direct bathroom area may hear the output of the speaker(s) (making failure to use the apparatus obvious); and/or (2) utilizing a recording means to track the use of the activation means which also makes failure to use the apparatus obvious to someone monitoring the output of the recording means.

For example, the toothbrush speaker output could be a children's song that plays for the same amount of time that brushing of the teeth is desired. As discussed above, this song could be utilized as a signal to the parent's of the child that the apparatus is actually being used. Likewise the hand washing speaker output could utilize a song (or perhaps an animal sound) that plays for a minimum period of time that hand washing is desired and simultaneously acts as a signal to the child's parents that the hand washing activation means is being used. Alternatively (or perhaps in tandem with songs or various noises) the speaker means could be designed to give directions and helpful hints concerning either hand washing or tooth brushing. For example, in the tooth brushing mode the speaker may be programmed or pre-recorded to say how to brush the teeth (e.g. with an up and down motion and/or prompt children to switch from upper teeth to lower teeth or side to side at some preset intervals).

Also it is possible that the toothbrush or hand wash speaker/transducer may be programmed to give trivia questions and answers to a user. This use of trivia may be helpful to assure that the user wants to stay in the vicinity for the required time to hear the answer to the question posed. The trivia (e.g. educational, pop culture, age specific facts of interest and so forth) can be designed to appeal to different target audiences (e.g. kids between 5-9 year of age and so forth). For example the tooth brush timer/speaker may be designed to ask one (or perhaps multiple questions) at the start of the brushing of the teeth. It could then be designed to not answer the question posed until the desired tooth brushing time (e.g. 2 minutes) is complete. This delay may keep the user in the area (and brushing their teeth) in anticipation of hearing the answer (answers) to the question (or questions) posed. With masked ROM memory (and other memory types) getting cheaper and cheaper it is possible to put dozens, hundreds or even thousands of questions and answers on a single memory chip/cartridge. These software/memory chips/cartridges can then be replaced with new cartridges after the user has heard all the trivia on a particular chip. With the hand wash timer, the delay between the question and answer is much less (e.g. 20 seconds or less) because of the smaller duration of hand washing.

The speaker output resulting from the use of the tooth brush and/or hand washing activation means may over some period of time have a Pavlovian effect. As the speaker output (e.g. directions/tips, songs, beeps, animal noises, etc) is heard routinely, people (both the children and parents) become accustomed to hearing the speaker output. As users develop their hygiene routines, failure to use either activation means (thereby triggering the speaker means) becomes obvious to both the children and their parents. This may have the effect of transforming an essentially voluntary action (triggering the activation means) into almost a reflexive action.

The speaker output for both hand washing and teeth brushing (or either separately) may act as both a reminder and as a positive reinforcement mechanism. It is possible that children in households would be praised each time the speaker output is heard by the parents. In addition, to make it's use more fun or less or less boring/annoying, there could be a series of different songs or noises (or even directions/tips) that could be chosen from a menu. These songs or sounds could be changed as the child ages or as the child or parents become annoyed by the same song or sound playing over and over again. In this case, it may also be possible to bypass or disengage the speaker output and utilize solely the non-audible display means as the method of facilitating better hand or teeth hygiene (e.g. the apparatus is silent but the child and/or parent can visually monitor the display means which may give information on the duration of hand washing or tooth brushing).

To help save space on what may be a crowded wash basin counter top, the apparatus may also be utilized as a tooth brush holder. In this mode, the removal of the tooth brush from the apparatus may be used to activate the tooth brush activation means. Methods of accomplishing this are set forth in U.S. Pat. No. 5,864,288 which is incorporated herein by reference. In this particular mode of the invention, it is possible that if the tooth brush is replaced in it's holder before the required brushing time is finished that an alarm or signal or a record of the non-compliance is noted. Finally in this particular mode, because of the time lag between removal of a tooth brush and actual brushing of the teeth (especially with young children) it is also possible that while the removal of the tooth brush activates the speaker means, a second activation means (as shown below in FIGS. 1 and 2) with a different speaker output is also used in this mode of the invention. For example, removal of the toothbrush prompts the user to apply sufficient tooth paste to the brush and wet it and then prompts the user to then push the tooth brush activation means to start a new speaker output which directs the user on the correct way to brush their teeth or on the desired duration of tooth brushing. With fun or fanciful speaker outputs, it is possible that the apparatus becomes a kind of game for a child which goes beyond simply teaching them better hygiene habits.

Another means of helping to coerce or urge use of the apparatus could be a display means which records and/or displays information relating to use of the apparatus. Examples of information that might be displayed are a frequency of use of the tooth brush activation means and/or hand washing activation means and/or particular times they were used. In this manner, for example, a parent could, at the end of a day (or week), check how often a child had used the device and the timing of its use. It could be used to see trends in hand washing and tooth brushing and reward positive behavior and attempt to change insufficient tooth brushing and/or hand washing. The recording means may also be used as the output of the activation means (bypassing or replacing the speaker means) and could be designed to visually signal information on hand washing or tooth brushing instead of using a speaker means to do so (e.g. alpha numeric instructions and/or color coded signals such as a red light indicating further washing or brushing is necessary and a green light signaling that the time is up).

The present invention may be used in any situation where it is desirable that a person wash their hands and brush their teeth.

It is a technical advantage of the present invention that it is an extremely simple and inexpensive system and method which can be easily placed in any bathroom area. It is another technical advantage of the present invention that the apparatus is helpful in improving both hand washing habits and tooth brushing habits.

Other technical advantages of the present invention should be apparent from the drawings and specification.

### BRIEF DESCRIPTION OF THE DRAWINGS

A more complete and thorough understanding of the present invention and advantages thereof may be acquired by referring to the following description taken in conjunction with the accompanying drawings, in which like reference numbers indicate like features, and wherein:

FIG. 1 is a side view of the exterior of one embodiment of an apparatus which comprises tooth brush activation means and hand washing activation means according to teachings of the present invention; and

FIG. 2 is a cross-sectional view of the device of FIG. 1 showing an internal structure of the tooth brush activation means and hand wash activation means according to teachings of the present invention.

FIG. 3 shows a side exterior view of a mode of the invention where the apparatus also is a toothbrush holder.

### DETAILED DESCRIPTION OF THE INVENTION

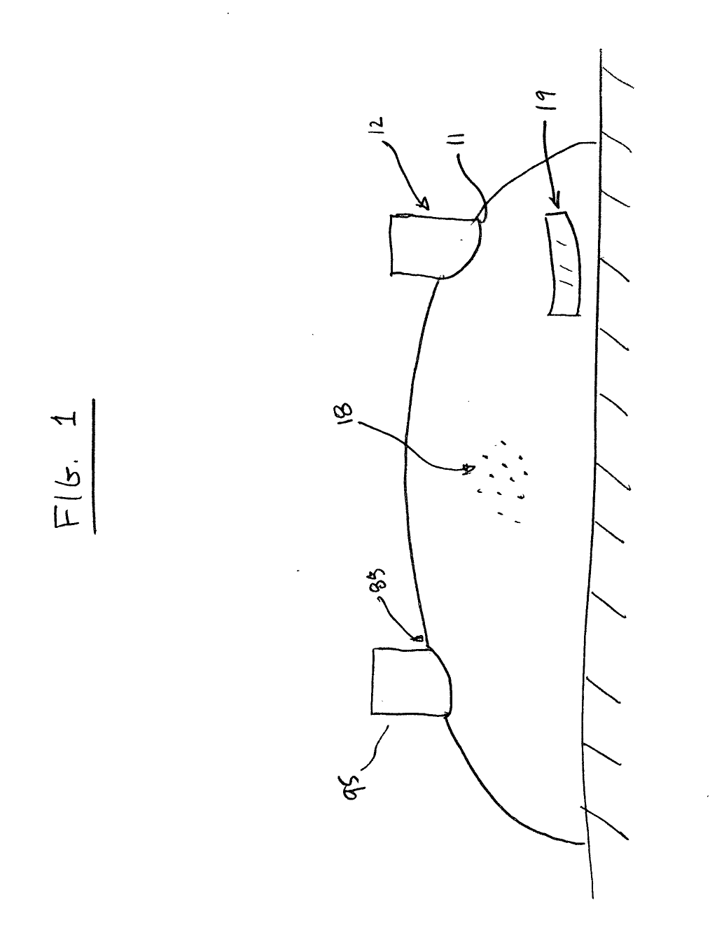

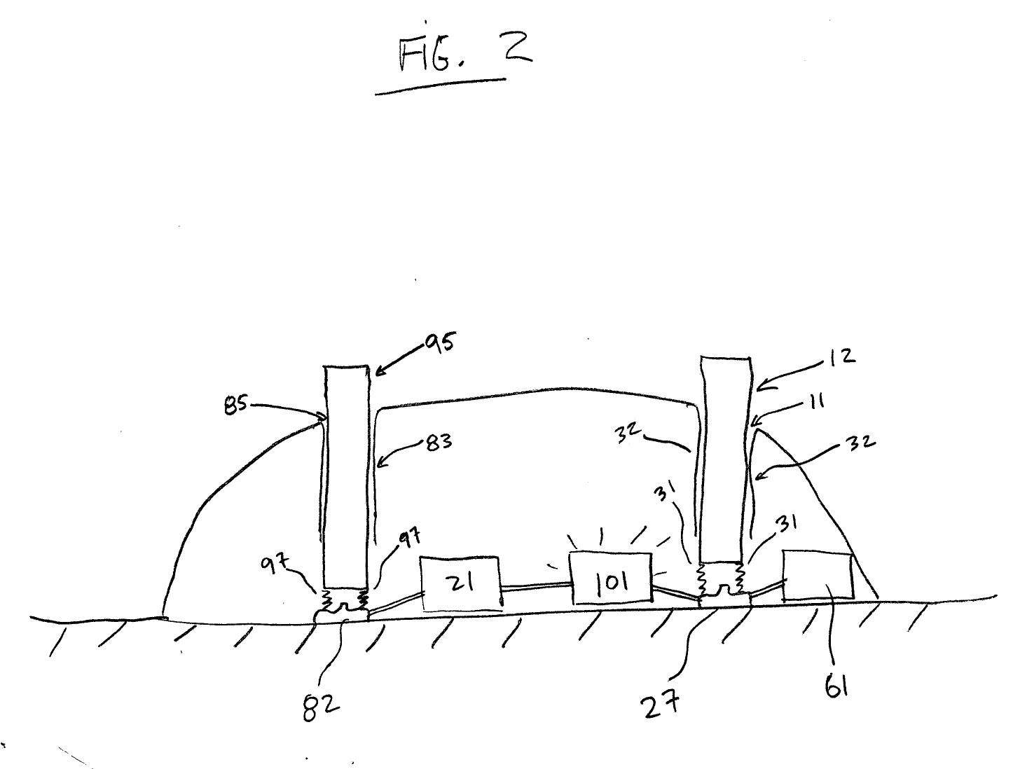

FIG. 1 is a horizontal exterior view of one embodiment of an apparatus having both a tooth brush activation means and hand wash activation means. In the embodiment of FIG. 1, cover 10, has a first opening 85 which is sized to accept first cylinder (or button) 95 and which, as shown below, may be used as the tooth brush activation means. (There may be multiple openings able to hold multiple tooth brushes). As first cylinder 95 is pushed or depressed into first opening 85, it triggers a switch which communicates with the speaker means and/or recording means (all shown in FIG. 2) which gives information to a user concerning brushing of their teeth. The speaker means and/or recording means may also contain a controller, or be coupled with or integral with a controller in which mode the controller gives instructions to the speaker means allowing for variable outputs.

The apparatus preferably also has a second opening 11 for second cylinder (or button) 12 which as shown below may be used for the hand wash activation means. (Note: the hand wash activation means and tooth brush activation means may be interchangeable).

Additionally, cover 10 includes speaker openings 18 and display window 19. Display window 19, can be any of a number of different type of displays including electronic displays such as an LED which can display alphanumeric information coming from recording means 61. (Note: it is possible that with current integrated circuit designs, such as system on a chip or ASICs, that the switching means, recording means, control means, speaker means and display means could all be present on the same integrated circuit). Display window 19, may also be designed such that it shows compliance (or lack thereof) with hand wash timing requirements or tooth brush timing requirements by use of color coded lights. For example, the display window could have a red light showing during the time period when further washing or brushing is necessary and a green light when the minimum time period has elapsed. Cover 10 is preferably designed to sit substantially flat on a surface such as a table, sink or counter. Cover 10 may also be configured to mount on a wall or other vertical surface. The shape of cover 10 may be varied. For example for use with children, it may be desirable to make cover 10 in the shape of an animal or action hero. In a further example, it may be desirable to match the audible signals of the device with the shape of the cover (e.g. having a frog shaped cover making a croaking noise as the timing means or signal).

Preferably inserted through second opening 11 is second cylinder 12. Second cylinder (or button) 12 is preferably movable up and down through opening 11. As shown below, cylinder 12 may be used as the hand wash activation means. As second cylinder 12 is pushed or depressed into second opening 11, it a switch which communicates with the speaker means and/or recording means (all shown in FIG. 2) which gives information to a user concerning brushing of their teeth. The speaker means and/or recording means may also contain a controller, or be coupled with a controller, which gives instructions to the speaker means allowing for variable outputs.

FIG. 1, also shows display window 19 which is preferably operable to display information concerning the use of the hand wash activation means and/or tooth brush activation means (e.g. frequency of use, timing of use, user identification, as well as other characteristics).

FIG. 2 is a cross-sectional view of the device of FIG. 1 showing an exemplary configuration of the present invention. FIG. 2 shows a first opening 85 which is defined by first interior walls 83. First opening 85 and first interior walls 83 are sized to accept first cylinder 95. Speaker means 101 and recording means 61 are preferably activated when first switch 82 is activated. In the exemplary example set forth in FIG. 2, first switch 82 is preferably activated when first cylinder 95 is pushed downward. The normal unbiased position of cylinder 95 is an upward position which may be facilitated using springs 97 to push cylinder 95 upward.

Preferably included in cover 10 is a speaker means 101, power supply 21, and recording means 61. First switch 82 is activated by the pushing of cylinder/button 95 which by activating first switch 82 preferably allows power to flow from power supply 21 to speaker means 101 and electronic recording means 61. Accordingly, first switch 82 is preferably operable to selectively couple speaker means 101 and recording means 61 to power supply 21 via one or more wires 22 or other electrical conduits. First switch 82 may be implemented using a variety of technologies including but not limited to contact switches, micro-electro-mechanical switches, pushbutton, toggle, slide, weight sensitive switches, light switches, lever switches, photoelectric switches, magnetic (e.g. Hall effect, reed switches, etc), disruption of a laser or light beam, inductive and so forth. Any type of switch may be used for either the tooth brush activation means or hand washing activation means without departing from the scope and spirit of this invention.

As speaker means 101 is activated by the depression of cylinder/button 95, it may begin to give information to the user concerning the brushing of their teeth. The information, given off by speaker means 101 can be of a great variety. The speaker means (e.g a transducer) may also have an integrated or separate memory means which holds the data necessary to for the speaking means to “say” various things. In the case of a trivia apparatus the memory cartridge may be able to be replaced easily with another memory cartridge with differing information so that the information being communicate remains fresh to the user.

The information communicated by the speaker means can be very detailed such as the trivia or a recording of actual instructions on how to brush one's teeth (e.g. the correct motion to use; how much tooth paste to use; how to brush the tongue; and how long to spend on each specific region of the mouth). Or it can be very simple, such as giving an indication of what the correct amount of total time for tooth brushing can be (e.g. with the playing of a song, beeps or signals, or statements such as “OK, congratulations, you have now brushed your teeth for a full two minutes”). Speaker means 101 is preferably an integrated circuit (such as a EEPROM) which can be preprogrammed or recorded to play any desired audible signal or as described above a transducer, memory means and a processor which drives the transducer using digital information from the memory means. These speaker devices are well known in the art and very inexpensive ones of a small size can be found in children's toys.

FIG. 2 shows that second cylinder/button 12 is preferably movable within the interior of cover 10 and may be guided within a specific channel by second interior walls 32 which defines a second opening 11. Speaker means 101 and recording means 61 are preferably activated when second switch 27 is activated. In the exemplary example set forth in FIG. 2, second switch 27 is preferably activated when second cylinder 12 is pushed downward. The normal unbiased position of second cylinder 12 is an upward position which may be facilitated using springs 31 to push second cylinder 12 upward.

Recording means 61 (which may record information on either hand washing and tooth brushing) is preferably maintained in communication with display window 19. Display window 19 preferably displays information on the exterior of cover 10 information recorded by recording means 61. This information, for example, may be things such as how many times the apparatus was activated during a particular period of time and the times of the activation, as well as other characteristics. Speaker 101 and recording means 61 are preferably activated when second switch 27 is activated. In the exemplary example set forth in FIG. 2, second switch 27 is preferably activated when cylinder 12 is pushed downward. The normal unbiased position of cylinder 12 is an upward position which may be facilitated using springs 31 to push cylinder 12 upward.

In an upward biased position, cylinder 12 is preferably not maintained in contact with second switch 27. And accordingly speaker means 101 and recording means 61 are preferably not activated and no sound or signal is produced by speaker means 101 nor is any activity recorded by recording means 61 in such circumstances.

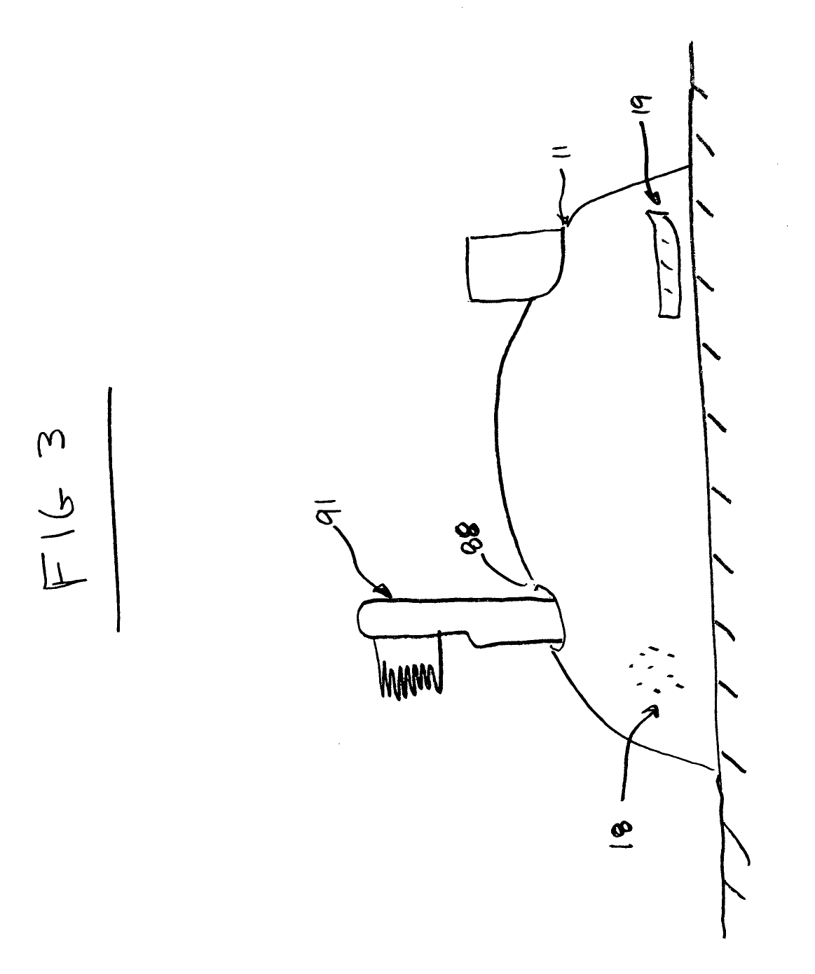

FIG. 3 shows an exterior side view of another embodiment of the subject invention where the apparatus is also used as tooth brush holder. In this case, cylinder/button 95 has been replaced with toothbrush 91 (any standard tooth brush) and opening 85 has been replaced with opening 88 which is sized to accept any standard toothbrush. Rather than pressing button 95 to activate the toothbrush portion of the apparatus (as in FIGS. 1 and 2), in this embodiment the simple act of pulling toothbrush 91 out of opening 88 activates the electronics in the apparatus. U.S. Pat. No. 5,864,288 (which is incorporate herein by reference) describes how one can use removal of a tooth brush from a holder to activate various types of electronic means.

For the various electronic devices in the subject invention (e.g. speaker means, switching means, recording means, display means, controlling means, power means and so forth), those skilled in the art, will be familiar with the use of various kinds of switches, power supplies, speakers, controllers, and timing means capable of generating sounds and displaying information. U.S. Pat. No. 5,864,288, the Hogan patent, which is incorporated herein by reference sets forth various means of sensing, switching, making audible sounds, timing, controlling and so forth. Any type of switch, speaker means, controlling means, power means, timing means and so forth, may be used for either the tooth brush activation means or hand washing activation means without departing from the scope and spirit of this invention.

Speaker means 101 can be any of a number of different technologies (e.g. traditional speakers or IC's with embedded sound capability). Persons skilled in the art may realize that speaker means 101 may be implemented using a variety of different technologies, including without limitation, one or more of the following: ICs, ASICs, EEPROMS, mechanical counters, as well as others. The specifics of the speaking means and or timing means (which can be combined in one device) is not important to the essence of this invention and could be done in a great number of different ways.

In an alternate embodiment of the invention (not expressly shown) a separate speaker/signal means may be located remote from the marking mechanism. This configuration may be desirable where a person monitoring hand washing or tooth brushing (e.g. parent of a young child) desires to have a signal indicating use be presented at a location other than where the marking mechanism is placed. For example, a parent may not be able to hear or detect the output from speaker means 101 if it is located remotely in the child's bathroom area. In such a case, the parent may desire to have one or more remote signal means in another area of the house such as the kitchen or living room. This may be done by hardwiring a a speaker or signal means to a remote location or using one or more wireless technologies. In general, remote communication may be facilitated by placing one or more transmitters/transceivers in communication with one or more receivers/transceivers. Examples of wireless technology capable of communicating in accordance with the teachings of the present invention include without limitation, IEEE 802.11x technologies, Bluetooth, GSM (Global system for mobile communications) 3GSM, CDMA, TDMA, infrared, radio spectrum, as well as others.

The wireless technology discussed immediately above may also be used to connect the apparatus of the subject invention to a remote recording means (not expressly shown). In this case, as an example, the output of the apparatus could be delivered wirelessly to a home computer or personal digital assistant (or even some other appliance like a TV) which could store and display information on tooth brushing and hand washing.

Persons skilled in the art may realize that recording means 61 may be implemented using a variety of different technologies, including without limitation, one or more of the following: IC, ASIC, EEPROM, memory and processor combinations, mechanical counters, as well as others. With integrated circuits getting cheaper and cheaper as Moore's Law drives down semiconductor costs, it is possible that a great of variety of different types of information may be cheaply collected, stored and displayed. In fact in a scenario with many users of the invention, it may be desirable to track the actions of specific people and their use of the marking mechanism by having the people wear electronic badges (e.g. RFID devices) or using biometrics which allow recording means 61 to differentiate the actions of different persons using the apparatus. The timing of the use of the present invention may also be compared with the timing of the use of soap dispensers, tooth past dispenser, water faucets or other devices used in hygiene processes. Lastly, recording means 61 may be able to be integrated into the integrated circuit or device which houses the speaker means 101.

The combination of hand washing facilitation and tooth brushing facilitation results in an apparatus which helps people improve a person's personal hygiene habits in two crucial areas.

Although the present invention has been described with respect to a specific preferred embodiment thereof, various changes and modifications may be suggested to one skilled in the art and it is intended that the present invention encompass such changes and modifications.

We claim,

1. An apparatus for improving a person's hygiene by sharing information which helps in hand washing and tooth brushing, comprising;
(a) hand wash information sharing means; and
(b) tooth brush information sharing means.

2. The apparatus of claim 1, wherein the information shared on hand washing and tooth brushing relates to the desired duration of hand washing and tooth brushing.

3. The apparatus of claim 1, wherein the hand wash sharing information means and tooth brush information sharing means are triggered by buttons.

4. The apparatus of claim 1 wherein the information shared is trivia in the form of questions and answers.

5. The apparatus of claim 4 wherein the questions and answers are timed such that the person knows the correct duration for hand washing and tooth brushing.

6. The apparatus of claim 5 wherein a delay between the question and the answer is used to encourage the person to continue using the apparatus until the answer is given.

7. A tooth brush holder apparatus for improving a person's hygiene by sharing information which encourages improved tooth brushing and hand washing, comprising;
(a) hand wash information sharing means; and
(b) tooth brush information sharing means.

8. The tooth brush holder apparatus of claim 7 wherein the tooth brush information sharing means is triggered by removal of a tooth brush from the tooth brush holder.

9. The apparatus of claim 8, wherein the information shared on hand washing and tooth brushing relates to the desired duration of hand washing and tooth brushing.

10. The apparatus of claim 8 wherein the information shared is trivia in the form of questions and answers.

11. The apparatus of claim 10 wherein the questions and answers are timed such that the person knows the correct duration for hand washing and tooth brushing.

12. The apparatus of claim 11 wherein a delay between the question and the answer is used to encourage the person to continue using the apparatus until the answer is given.
